(19) United States
(12) Patent Application Publication
(10) Pub. No.: US 2018/0031403 A1
(43) Pub. Date: Feb. 1, 2018

(54) THERMAL, FLOW MEASURING DEVICE WITH DIAGNOSTIC FUNCTION

(71) Applicant: Endress + Hauser Flowtec AG, Reinach (CH)

(72) Inventors: Martin Arnold, Reinach (CH); Axel Pfau, Wehr (DE)

(21) Appl. No.: 15/535,446

(22) PCT Filed: Dec. 3, 2015
(86) PCT No.: PCT/EP2015/078527

§ 371 Date: Sep. 12, 2017

(30) Foreign Application Priority Data
Dec. 19, 2014 (DE) 102014119231.1

(51) Int. Cl. G01F 1/696

(52) U.S. Cl. CPC G01F 1/696

(57) ABSTRACT

A thermal, flow measuring device for determining and/or monitoring the mass flow (φ_{M}) and/or the flow velocity (v_{F}) of a flowable medium through a pipeline, comprising at least three sensor elements and an electronics unit, as well as method for operating a thermal, flow measuring device. Each sensor element is at least partially and/or at times in thermal contact with the medium, and includes a heatable temperature sensor. The electronics unit is embodied to heat each of the three sensor elements with a heating power, to register their temperature, to heat at least two of the at least three sensor elements simultaneously, continuously to ascertain the mass flow (φ_{M}) and/or the flow velocity (v_{F}) of the medium, and, simultaneously, from a pairwise comparison of the temperatures and/or heating powers, to provide information concerning the state of at least one of the at least three sensor elements, and in the case that a malfunction and/or a deposit occurs on at least one of the at least three sensor elements, to perform a correction of the measured value for the mass flow (φ_{M}) and/or the flow velocity (v_{F}) and/or to generate and to output a report concerning the state of the at least one sensor element.

The invention relates to a thermal, flow measuring device, especially a thermal, flow measuring device for determining and/or monitoring the mass flow and/or the flow velocity of a flowable medium through a pipeline, comprising at least three sensor elements and an electronics unit, as well as to a method for operating such a flow measuring device. Furthermore, information concerning the state of at least one of the at least three sensor elements can be provided. The flow measuring device thus includes a diagnostic function.

Thermal flow measuring devices are widely applied in process measurements technology. Corresponding field devices are manufactured and sold by the applicant, for example, under the marks, t-switch, t-trend or t-mass. The underpinning measuring principles are known from a large number of publications.

Typically, a flow measuring device of the field of the invention includes at least two sensor elements, of which each has a temperature sensor embodied as equally as possible. At least one of the sensor elements is embodied heatably. In this regard, a sensor element can contain a supplemental resistance heater. Alternatively, however, the temperature sensor can also be embodied as a resistance element, e.g. in the form an RTD resistance element (Resistance Temperature Detector), especially in the form of a platinum element, such as also commercially obtainable under the designations PT10, PT100, and PT1000. The resistance element, also referred to as resistance thermometer, is then heated via conversion of electrical power supplied to it, e.g. as a result of an increased electrical current supply.

Often, the temperature sensor is arranged within a cylindrical shell, especially a shell of a metal, especially stainless steel or Hastelloy. The shell functions as a housing, which protects the temperature sensor, for example from aggressive media. In the case of the respective at least one heatable temperature sensor, it must additionally be assured that a best possible thermal contact is provided between the heatable temperature sensor and the shell.

For registering the mass flow and/or the flow velocity, the at least two sensor elements are introduced into a pipeline, through which flows, at least at times and at least partially, a flowable medium. The sensor elements are in thermal contact with the medium. They can, for this, either be integrated directly into the pipeline, or into a measuring tube installable in an existing pipeline. Both options are subject matter of the present invention, even when in the following only a pipeline is discussed.

In operation, at least one of the at least two temperature sensors is heated (the active temperature sensor) while the second temperature sensor remains unheated (the passive temperature sensor). The passive temperature sensor is applied for registering the temperature of the flowable medium. The terminology, temperature of the medium, means, in such case, the temperature, which the medium has without an additional heat input of a heating unit. The active sensor element is usually either so heated that a fixed temperature difference is established between the two temperature sensors, wherein the change of the heating power is taken into consideration as measure for the mass flow and/or the flow velocity. Alternatively, however, also the fed heating power can be kept constant, so that the corresponding temperature change is taken into consideration for determining the mass flow and/or the flow velocity.

If no flow is present in the pipeline, the removal of the heat from the active temperature sensor within the medium occurs via heat conduction, heat radiation and, in given cases, also via free convection. For maintaining a certain temperature difference, then, for example, a constant amount of heat is required as a function of time. In the presence of a flow, in contrast, there is an additional cooling of the active temperature sensor from the flow of the flowing, colder medium. An additional heat transport occurs due to forced convection. Correspondingly, thus, as a result of a flow, either an increased heating power must be supplied, in order to maintain a fixed temperature difference, or else the temperature difference between the active and passive temperature sensors lessens.

This functional relationship between the heating power supplied to the active temperature sensor, or the temperature difference, and the mass flow and/or the flow velocity of the medium through the pipeline can be expressed by means of the so-called heat transfer coefficient. The dependence of the heat transfer coefficient on the mass flow of the medium through the pipeline is then used for determining it and/or the flow velocity. Along with that, the thermophysical properties of the medium as well as the pressure reigning in the pipeline have an influence on the measured flow. In order also to take into consideration the dependence of the flow on these variables, the thermophysical properties are, for example, furnished within an electronics unit of the flow measuring device in the form of characteristic curves or as parts of functional, determinative equations.

It is not possible by means of a thermal, flow measuring device to distinguish directly between a forwards directed and a backwards directed flow. In such case, the terminology, flow direction, means, here the macroscopic flow direction, such that partially occurring vortex or directional deviations are not taken into consideration. If the flow direction is not known, then especially in the case of flow not constant as a function of time or also very low flows, considerable measurement errors can disadvantageously be experienced in the determining of mass flow and/or flow velocity.

Various thermal, flow measuring devices have been developed and disclosed, which have besides the determining of mass flow and/or flow velocity a supplemental functionality for flow direction detection. For ascertaining the flow direction, frequently utilized is the fact that different local flows, which directly surround the particular sensor element, lead to different cooling rates of the respective sensor element in the case of respectively equal supplied heating power. Different local flows can be implemented, for example, by integrating a bluff body into the pipeline in the direct vicinity of at least one of the at least two sensor elements, by a non-equivalent arrangement of the at least two sensor elements with reference to the flow profile, or also by different geometric embodiments of the at least two sensor elements.

In the case of the flow measuring device of DE102010040285A1, for example, a plate is arranged within a measuring tube on a connecting line between a first and a second heatable temperature sensor. Based on comparison of so-called decision coefficients, which result from the respective heating powers and temperatures of the at least two heatable temperature sensors, then the flow direction of the medium is ascertained. These decisions coefficients are likewise taken into consideration in patent publications DE102009045956A1 and DE102009045958A1 for determining the flow direction. In such case, the flow measuring device of DE102009045956A1 includes a flow guiding body, which together with a heatable temperature sensor is arranged in a line essentially parallel to the pipeline axis, and a further temperature sensor is arranged spaced therefrom. In contrast, in the case of the flow measuring device of DE102009045958A1, at least two heatable temperature sensors are arranged in two sleeve sections, and the at least two sleeve sections point in at least two directions with reference to the measuring tube axis.

In DE102007023840B4, a thermal, flow measuring device with flow direction detection is described, which includes at least three sensor elements, whereof two sensor elements are arranged one after the other in the flow direction and at least one of these two sensor elements is heated, and at least at times in reference to the flow direction the heated sensor is arranged in front of the non-heated sensor element, and at times the non-heated sensor is arranged in front of the heated sensor element. The third sensor element is, furthermore, periodically temporarily heatable and arranged outside the flow across the first two sensor elements. The deviation of the respectively won measured values is then a measure for the flow direction of the medium.

Other causes for an, in given cases, considerable, measured value corruption lie, for example, in a change of the thermal resistance of at least one of the utilized sensor elements, which can lead to a change of the heat transfer from the heating unit into the medium in the case of otherwise constant flow conditions. Such a change of the thermal resistance is also referred to as sensor drift. In given cases, when the change of the effective thermal resistance remains below a certain predeterminable limit value, and in case the change is detected, the sensor drift as well as the negative influence on the determining of the mass flow and/or the flow velocity can at least partially be removed by suitable countermeasures. Otherwise, in given cases, the flow measuring device must at least partially be replaced.

Fundamentally with reference to the thermal resistance, a distinction is made between an inner thermal resistance and an outer thermal resistance. The inner thermal resistance depends, among other things, on individual components within the sensor element, e.g. within the sleeves. Thus, sensor drift can arise from defects in solder connections due to tensile loads from material expansion or the like. The outer thermal resistance is, in contrast, influenced by accretion, material removal or material transformation (e.g. corrosion) on the surfaces of the respective sensor element contacting the medium. A change of the outer thermal resistance is, thus, especially relevant in the case of long periods of operation and/or contact with aggressive media. In the case of gaseous- or vaporous media, the measuring of mass flow or flow velocity can, moreover, also be degraded by condensate formation on at least one of the temperature sensors.

Known from the state of the art are a number of flow measuring devices, by means of which a diagnosis concerning at least one of the sensor elements can be actuated. Thus information concerning the state of at least one of the sensor elements is provided.

DE102005057687A1 describes a thermal, flow measuring device having at least two heatable temperature sensors, wherein the first temperature sensor and the second temperature sensor are alternately operable as a passive, non-heated temperature sensor, which during a first measurement interval provides information concerning the current temperature of the medium, and as an actively heated temperature sensor, which during a second measurement interval provides information concerning the mass flow of the medium through the pipeline. A control/evaluation unit issues a report and/or undertakes a correction, as soon as the corresponding measured values of the two temperature sensors provided during the first measurement interval and the second measurement interval deviate from one another. In this way, accretion and condensate formation can be recognized.

Similarly, disclosed in DE102007023823A1 is a thermal, flow measuring device having two, phasewise alternately heatable sensor elements as well as method for its operation. The mass flow is, in such case, alternately ascertained based on the respectively heated sensor element, wherein the respectively non-heated sensor element is referenced for ascertaining the temperature of the medium. From a comparison of the measured values with the two sensor elements, supplementally, a fouling of at least one of the two sensor elements can be detected.

Finally, described in U.S. Pat. No. 8,590,360 B2 are a first heatable sensor element with a first heating power to heat or to cool, and simultaneously a second heatable sensor element with a second heating power to heat or to cool. Typically, the two heating powers are so selected that the temperatures of the two sensor elements differ. Through a comparison of the temperature of the medium, and/or of at least two independent variables characterizing the heat transfer coefficient, then a diagnosis can be made concerning the flow measuring device.

Most of these flow measuring devices, which are suited for diagnosis of an accretion- and/or condensate formation or for providing information concerning the state of at least one sensor element, are, however, not able, simultaneously, to ascertain the flow and the diagnosis, or, simultaneously, the flow and the flow direction, or both. In the case of the respectively applied measuring principles, the individual sensor elements are at times heated, and serve at times for registering the temperature of the medium. Correspondingly, at each change of the temperature for one of the sensor elements, it is necessary to wait for the next measured value registering until the new temperature has, in each case, become stable. Thus, for example, the mass flow and/or the flow velocity cannot be continuously determined. Correspondingly, the methods assume an almost constant flow rate of the medium through the pipeline, at least during the time required for reaching a stable new temperature by at least one sensor element. However, it is in practice frequently the case that the flow rates vary at least slightly with time, which then can lead to a corrupted measurement result. This is especially problematic in the case of high flow rates.

Starting from the above described state of the art, an object of the present invention is a thermal, flow measuring device as well as a method for operating a corresponding flow measuring device, by means of which the mass flow and/or the flow velocity can be determined as exactly as possible.

Regarding the apparatus, the object is achieved by a thermal, flow measuring device for determining and/or monitoring the mass flow and/or the flow velocity of a flowable medium through a pipeline, comprising at least three sensor elements and an electronics unit, wherein each of the at least three sensor elements
is at least partially and/or at times in thermal contact with the medium, and
includes a heatable temperature sensor, wherein the electronics unit is embodied,
to heat each of the three sensor elements with a heating power,
to register their temperatures,
to heat at least two of the at least three sensor elements simultaneously,
continuously to ascertain the mass flow and/or the flow velocity of the medium, and, simultaneously,
to provide information concerning the state of at least one of the at least three sensor elements, and in the case that a malfunction and/or a deposit occurs in the case of at least one of the at least three sensor elements, to perform a correction of the measured value for the mass flow and/or the flow velocity and/or to generate and to output a report concerning the state of the at least one sensor element.

The supplied heating power can, in such case, be either constant, thus correspond to a fixed value, or adjustable, in such a manner that in ongoing operation the supplied heating power can be changed and/or controlled.

The electronics unit must thus be able to heat each of the three sensor elements independently of one another, as well as at least two simultaneously. At least one of the sensor elements remains, furthermore, unheated and serves for registering the temperature of the medium. In the case, in which for determining the mass flow and/or the flow velocity a constant temperature difference is set between at least one heated sensor element and that, which displays the temperature of the medium, the electronics unit should have at least two control units for controlling the heating power supplied to each of the heated sensor elements. Thus, for example, one of the at least two heated sensor elements can be applied for ascertaining the mass flow and/or the flow velocity and the other for diagnosis. Advantageously, a separate control unit is present for each of the heated sensor elements, in order that in the ongoing operation any combination of heated and non-heated sensor elements is selectable. If the mass flow and/or the flow velocity is, however, determined from the temperature difference, which results between a heated and an unheated sensor element in the case of supplying a constant heating power, then each of the three sensor elements should individually be able to be fed a determinable, however, constant heating power. It is then possible to compare both the temperature differences between, in each case, one of the heated sensor elements and that which registers the temperature of the medium, as well as also the temperature differences between two sensor elements heated to different temperatures.

In this way, that each of the at least three sensor elements is individually heatable, and thereby, that, in each case, at least two of the at least three sensor elements are simultaneously heatable, the mass flow and/or the flow velocity can be continuously and very exactly determined. At the same time, a diagnosis, thus information concerning the state of at least one of the at least three sensor elements, is possible. A further advantage in reference to a flow measuring device of the invention is that not only information is possible that at least one of the at least three sensor elements shows a sensor drift, but also which of the at least three sensor elements is affected. Then, in the case of sensor drift at one of the sensor elements, the flow can nevertheless still be exactly determined. If, for example, sensor drift is detected in the case of a first sensor element, it is possible without interruption to switch to a second sensor element for determining the mass flow and/or flow velocity.

In an especially preferred embodiment, the electronics unit is embodied to determine the flow direction of the flowable medium. A flow measuring device corresponding to this embodiment offers then, thus, besides the supplemental functionality of being able to provide a diagnosis, e.g. information concerning the state of at least one sensor element, also a flow direction detection. This increases the achievable accuracy of measurement yet further.

Another embodiment includes that the electronics unit is embodied, without interruption, thus continuously, to ascertain the mass flow and/or the flow velocity, to determine the flow direction of the medium and/or to provide information concerning the state of at least one of the at least three sensor elements.

It is advantageous when at least one of the at least three sensor elements has a first embodiment with reference to the geometry, construction and material, and at least a second of the at least three sensor elements has a second embodiment different from the first. It is, furthermore, advantageous, when at least two of the at least three sensor elements are arranged at first positions within the pipeline equivalent with reference to locally surrounding flow of the medium, and wherein at least one of the at least three sensor elements is arranged at a second position within the pipeline different from the first positions with reference to locally surrounding flow of the medium. The different geometric embodiments and/or arrangements of the individual sensor elements within the pipeline means also that the cooling rate brought about by the flow of the medium is different for each of the sensor elements. This is especially advantageous for detecting the flow direction, however, also for the diagnosis concerning sensor drift. The reason for this is that the characteristic curves, respectively the functional dependencies between the temperatures, the supplied heating powers, as well as the thermophysical properties and also other parameters of the individual sensor elements differ for forwards and backwards directed flow.

In a preferred embodiment, at least one of the at least three sensor elements is arranged with reference to the longitudinal axis of the pipeline in the direct vicinity before or behind a bluff body, or other flow influencing module. In such case, it is advantageous, when the cross sectional area of the bluff body is a triangle, a rectangle, a parallelogram, a trapezoid, a circle or an ellipse. By this measure, the local flow profile surrounding the particular sensor element is changed, with targeting, in comparison to a sensor element not arranged behind a bluff body, or in comparison to a sensor element arranged behind a bluff body of different geometry. The effect achieved by integration of a bluff body is, in such case, as a rule, greater than that, which results from different geometric embodiments or arrangements.

In an especially preferred embodiment, the thermal, flow measuring device includes exactly three sensor elements, wherein at least one of the three sensor elements is arranged in the direct vicinity of a bluff body, or another flow influencing module. In such case, it is advantageous, when the first and second sensor elements are arranged symmetrically on oppositely lying sides of an imaginary axis parallel to the pipeline, wherein the third sensor element is arranged on the imaginary axis, and wherein between the imaginary connecting line through the first and the second sensor elements and the third sensor element a bluff body is arranged, whose separation from the third sensor element is less than that from the imaginary connecting line.

The object of the invention is, furthermore, achieved by a method for operating, in a normal operating mode and in a diagnostic mode, a thermal, flow measuring device for determining and/or monitoring the mass flow and/or the flow velocity of a flowable medium through a pipeline and having at least three sensor elements and an electronics unit, as claimed in at least one of the preceding claims, wherein in the normal operating mode at least one of the at least three sensor elements is heated with a tunable heating power, and its temperature registered, and the mass flow and/or the flow velocity of the medium is determined, and

wherein in the diagnostic mode at least steps are performed as follows:

a first sensor element is heated with a first heating power and its temperature registered,

a second sensor element is heated with a second heating power and its temperature registered,

the temperature of the medium is registered by means of a non-heated, third sensor element,

from the heating power and/or temperature of the first or second sensor element and/or at least one variable derived from at least one of these variables, the mass flow and/or the flow velocity of the medium is continuously determined, and, simultaneously,

from a pairwise comparison of the temperatures and/or heating powers of the first and/or second sensor element and the temperature of the third sensor element and/or from at least one variable derived from the temperatures and/or heating powers, information is derived concerning the state of at least one of the at least three sensor elements and/or a correction of the measured value for the mass flow and/or the flow velocity performed and/or a report concerning the state of at least one of the at least three sensor elements generated and output.

In this way, mass flow and/or a flow velocity can be continuously and exactly determined. At the same time, a diagnosis, thus information concerning the state of at least one of the at least three sensor elements, is available. The diagnosis is not just limited to information that the thermal resistance of at least one of the sensor elements has changed. The method of the invention enables, in given cases, rather, to provide information on which of the three sensor elements has a changed thermal resistance, or for which the thermal resistance is still constant. In such case, the supplied heating powers and/or the temperatures for at least two simultaneously heated sensor elements can be tuned either to the same value or to different values.

A preferred variant of the method of the invention provides that the flow direction of the medium is ascertained from a pairwise comparison of the temperatures and/or heating powers and/or from at least one variable derived from the temperatures and/or heating powers.

In an additional preferred embodiment of the method, the mass flow, the flow velocity, the flow direction of the medium and/or information concerning the state of at least one of the at least three sensor elements are ascertained without interruption and at the same time.

It is, furthermore, advantageous, when, before the simultaneous heating of at least two of the at least three sensor elements with, in each case, a tunable heating power, a reconciliation of the measured media temperatures is performed, and, in given cases, a temperature correction term calculated and applied to all following measurements. In such case, the following cases can be considered: at start-up of the flow measuring device, a first and a second sensor element are heated. Before these sensors elements are supplied a heating power, the temperature of the medium is determined with both, or even with all sensor elements. If the values measured independently of one another deviate from one another, a temperature correction term is calculated. In this way, measured values deviating due to unpreventable manufacturing tolerances and differences in the respective calibrations can be canceled. Another case occurs when, during operation, the heated sensor elements are changed back and forth, so that a further temperature comparison is performed. In such case, of concern can be either the temperature of the medium or the temperatures at equal, supplied heating powers.

A preferred embodiment provides that a comparison of the power coefficients PC of the at least three sensor elements is performed. The power coefficient PC results from a comparison of the heating power P supplied to a heatable sensor element S, as well as its temperature T, with the temperature of the medium T_{M} ascertained by means of an additional unheated sensor element S_{M} and is defined as

$$PC ( S , {S}_{M} ) = \frac{P}{T - {T}_{M}} .$$

Another preferred embodiment of the method is designed for a thermal, flow measuring device with exactly three sensor elements and includes method steps as follows:

In the normal operating mode, the first sensor element is fed a first heating power, its temperature registered, and the mass flow and/or the flow velocity determined,

in a first time interval of the diagnostic mode

the first and second sensor elements are heated,

the mass flow and/or the flow velocity are determined based on the first sensor element, and

a comparison of the power coefficients PC(S1, S3) and PC(S2, S3) performed,

in a second time interval of the diagnostic mode

the first and third sensor elements are heated,

the mass flow and/or the flow velocity are determined based on the first sensor element, and

a comparison of the power coefficients PC(S1, S2) and PC(S3, S2) performed, and the direction of the flowing medium ascertained therefrom, and in a third time interval of the diagnostic mode

the second and third sensor elements are heated,

the mass flow and/or the flow velocity are determined based on the second sensor element, and

a comparison of the power coefficients PC(S2, S1) and PC(S3, S1) performed, and the direction of the flowing medium ascertained therefrom.

Based on the comparisons of the power coefficients in the three time intervals, then information is derived concerning the state of at least one of the at least three sensor elements and a correction of the measured value for the mass flow and/or the flow velocity performed and/or a report concerning the state of the at least one sensor element generated and output.

Of course, in the case, in which the thermal, flow measuring device has more than three sensor elements, the diagnostic mode has then more than three time intervals.

A comparison of the power coefficients of various sensor elements can be performed, for example, based on the so-called decision coefficients DC mentioned above. The decision coefficient DC(S2, S1) between two sensor elements S1 and S2 is defined as

$$DC ( {S}_{2} , {S}_{1} ) = \frac{{PC}_{2} - {PC}_{1}}{{PC}_{1}}$$

wherein PC₁ and PC₂ are the power coefficients of the first and second sensor elements S₁ and S₂.

Depending on whether and when a change of the thermal resistance is present for which of the at least three sensor elements, it is, in given cases, not necessary to pass through all three time intervals.

Finally, according to the invention, also a drift of the electrical resistance within at least one of the at least three sensor elements can be ascertained. A sensor element can also drift without the occurrence of a change of the thermal resistance. This leads to a change of a characteristic curve of the electrical resistance as a function of temperature of the at least one sensor element, from which a defective temperature measurement results. A change of the electrical resistance within at least one sensor element can be detected here, i.e. ascertained, using a pairwise comparison of the power coefficients and, indeed, in the unheated state of the at least one sensor element, for example, based on the phases in the determining of the temperature correction terms. When the currently measured temperature correction terms deviate from those determined in the manufacturing of the particular sensor element and, for example, furnished within the electronics unit, and the deviation exceeds a predeterminable limit value, it can be deduced from the deviation that a change of the electrical resistance has occurred. In this way, a change of the thermal resistance and a change of the electrical resistance can be distinguished.

The invention as well as its advantages will now be explained in greater detail based on the appended drawing, the figures of which show as follows:

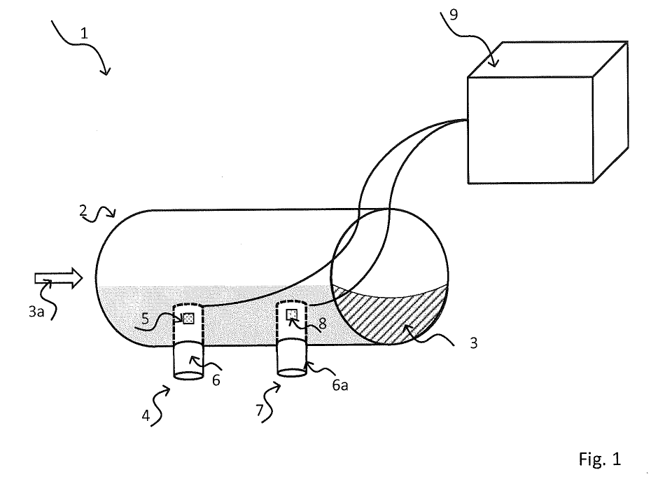

FIG. 1 a schematic view of a thermal, flow measuring device according to the state of the art,

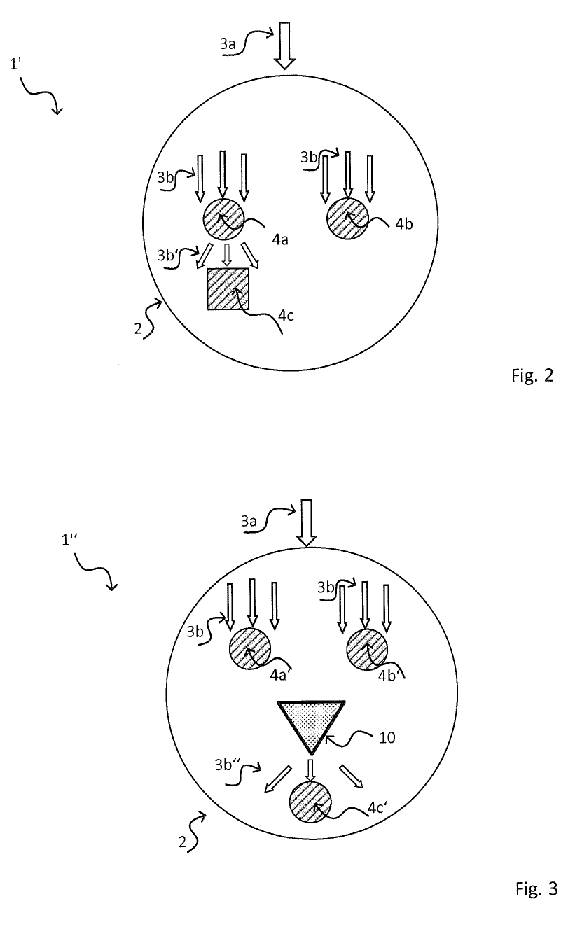

FIG. 2 a schematic view of a thermal, flow measuring device with three sensor elements of claim 4 and/or claim 5

FIG. 3 a schematic view of a thermal, flow measuring device with three sensor elements, of which one is arranged behind a bluff body,

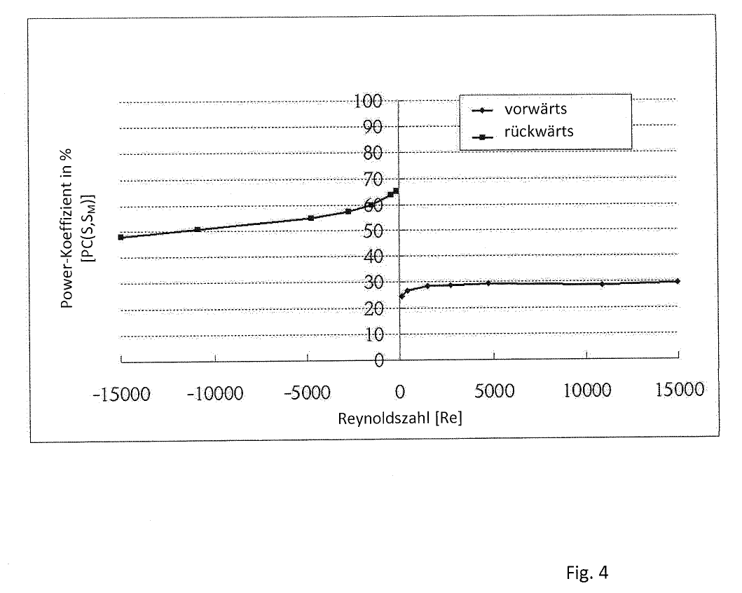

FIG. 4 a graph of decision coefficient characteristic curves as function of the Reynolds number for different flow directions, and

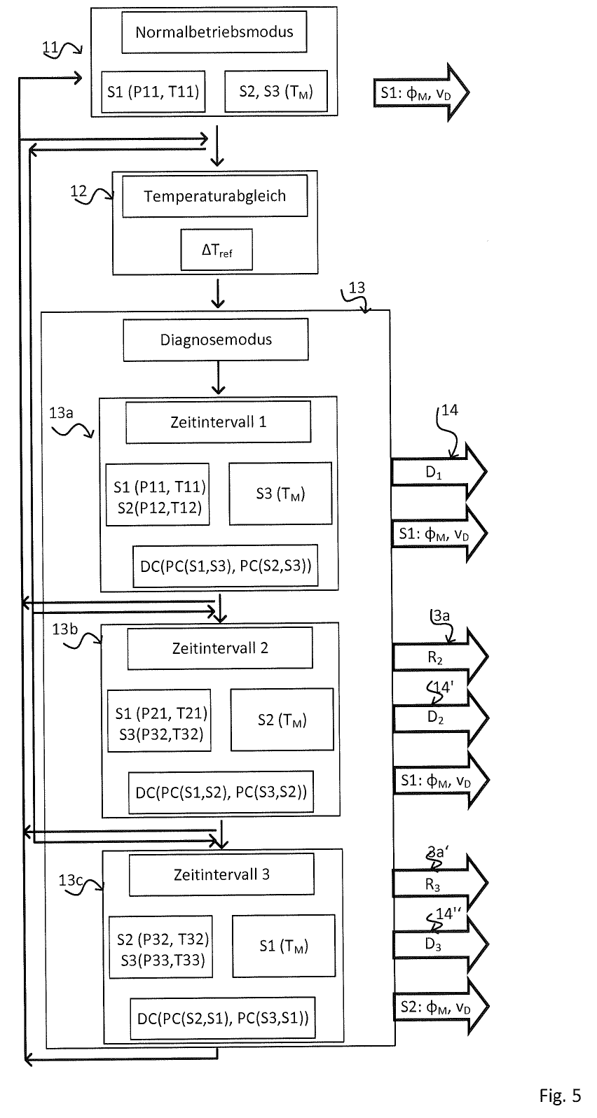

FIG. 5 a block diagram of an evaluation method option.

In the figures, equal features are provided with equal reference characters. The apparatus of the invention bears the reference character 1 in its totality. Primes on reference characters indicate different examples of embodiments.

FIG. 1 shows a thermal, flow measuring device 1 according to the state of the art. Sealedly integrated in a pipeline 2 flowed through by a medium 3 are two sensor elements 4,7, in such a manner that they are at least partially and at least at times in thermal contact with the medium 3. Each of the two sensor elements 4,7 includes a housing 6,6a, which, in this case, is embodied cylindrically, and in which are arranged respective temperature sensors 5,8. Especially, the two temperature sensors 5,8, of each of the two sensor elements 4,7 should be in thermal contact with the medium 3.

In this example, the first sensor element 4 as active sensor element is embodied such that it has a heatable temperature sensor 5. Of course, a sensor element 4 with external heating element, such as mentioned above, likewise falls within the scope of the present invention. In operation, it can correspondingly be heated to a temperature T1 by delivery of a heating power P1. The temperature sensor 8 of the second sensor element 7 is, in contrast, not heatable and serves for registering the temperature T_{M} of the medium.

Finally, the thermal, flow measuring device 1 includes also an electronics unit 9, which serves for signal registration, —evaluation and —feeding, or power supply. Known are thermal, flow measuring devices 1 with more than two sensor elements 4,7, as well as also the most varied of geometric embodiments and arrangements of the respective sensor elements 4,7.

By way of example, FIGS. 2 and 3 show two possible arrangements, or embodiments, of a thermal, flow measuring device 1 in a two-dimensional, sectional illustration through the pipeline. The macroscopic flow direction 3a of the medium 3 is shown by an arrow. The thermal, flow measuring device 1′ of FIG. 2 includes three active sensor elements 4a,4b,4c containing, in each case, a heatable temperature sensor (not shown). The first sensor element 4a and the second sensor element 4b have an equivalent geometric embodiment with a circularly shaped cross sectional area, and are arranged at two positions 3b within the pipeline 2 equivalent with reference to the local flow surrounding them. The third sensor element 4c has a second geometric embodiment different from the first with a square-shaped cross sectional area. Moreover, the third sensor element 4c is arranged at a second position 3b′ within the pipeline 2 with locally surrounding flow different from the first. The local flow profiles are indicated by arrows.

FIG. 3 shows a further thermal, flow measuring device 1″ in a two-dimensional sectional illustration. The medium 3 flows in the same direction 3a as in the example of FIG. 2. Also, this thermal, flow measuring device 1″ includes three active sensor elements 4a′, 4b′ and 4c′. Similarly as in FIG. 2, the first 4a′ and the second 4b′ sensor elements are arranged symmetrically on oppositely lying sides of an imaginary axis parallel to the pipeline, while the third sensor element 4c′ is arranged on the imaginary axis, wherein between the imaginary connecting line through the first 4a′ and second 4b′ sensor element and the third sensor element 4c′ a bluff body is arranged, whose separation from the third sensor element 4c′ is less than that from the imaginary connecting line. The first sensor element 4a′ and the second sensor element 4b′ are, furthermore, equivalently embodied. The bluff body 10 has a triangular cross sectional area. It is understood, however, that other geometric embodiments are possible for the bluff body 10. Bluff body 10 influences the flow profile 3a, so that a local flow 3b″ results for the third sensor element 4c′, which is changed compared with the local flows surrounding the sensor elements 4a′ and 4b′.

Different local flows 3b,3b′, 3b″ surrounding the various sensor elements 4a,4b,4c, 4a′, 4b′, 4c′ result in different cooling rates for them. The characteristic curves or functional, determinative equations referenced for determining the mass flow and/or the flow direction differ correspondingly. Moreover, due to different arrangements within the pipeline 2 or due to different geometrical embodiment, these characteristics curves, or functional relationships likewise differ for a forwards-, or backwards, directed flow 3a. These differences enable, for example, a reliable direction detection and correspondingly a more exact ascertaining of the mass flow and/or the flow velocity. By way of example, FIG. 4 shows a characteristic curve for the power coefficient of a calibrated heated sensor element S with reference to a passive, thus non-heated, sensor element S_{M} as a function of the Reynolds number Re for a forwards directed and for a backwards directed flow. At the point of reversal of the flow direction (Re=0), there is an abrupt change of the power coefficient. Moreover, the power coefficient for a forwards directed flow lies in the range from 20-30%, while the power coefficient for a backwards directed flow amounts to 50-60%. Correspondingly, based on this characteristic curve, the flow direction can be exactly determined, even when a sensor element exhibits only a small drift.

FIG. 5 shows, finally, a block diagram of a method option for operating a flow measuring device 1. The shown steps are for the example of a flow measuring device 1 with three sensor elements 4a,4b and 4c, especially for a flow measuring device 1″ such as shown in FIG. 3. Advantageously, the mass flow, or the flow velocity, can be determined continuously and with high accuracy of measurement. Additionally, the flow direction of the medium within the pipeline can be determined and information concerning the state of at least one of the at least three sensor elements provided. Ideally, it can even be ascertained, which of the three sensor elements 4a,4b,4c exhibits a change of the thermal resistance.

In the following for purposes of simplicity, the first sensor element, e.g. the sensor element referred to in FIG. 3 with 4a, is referred to with S1, the second sensor element, e.g. 4b, is referred to with S2 and the third, e.g. 4c, with S3.

In the normal operating mode 11, at least S1 is heated to a first temperature T11 by delivery of the heating power P11. S2 and S3, in contrast, remain unheated and serve for registering the temperature T_{M} of the medium. Of course, in principle, each of the three sensor elements S1, S2, S3 can be heated, or can remain unheated in the normal operating mode 11. From the heating power P11, the temperature T11 of the heated sensor element S1 as well as the temperature T_{M} of the medium, then the mass flow φ_{M}, or the flow velocity v_{F}, can be determined.

Before the so-called diagnostic mode 13 is activated, optionally a temperature reconciliation 12 can be performed. In such case, the temperatures of the two unheated sensor elements S2 and S3 are compared. In the case, in which a deviation ΔT_{2,3} of the measured values for the temperature T_{M} of the medium obtained by means of the two sensor elements is detected, a so called temperature correction term can be ascertained and applied in all following measurements, for example, in such a manner that T(S3)+ΔT_{kor,2,3}=T(S2).

In the diagnostic mode 13, different options are available. The basic idea is to supply, in different time intervals, two of the three sensor elements with equal or different heating powers and to leave one of the sensor elements unheated. From a pairwise comparison of the temperatures and/or heating powers of the two heated sensor elements and the temperature of the unheated sensor element and/or from at least one variable derived from the temperatures and/or heating powers, then information concerning the state of at least one of the at least three sensor elements can be provided and/or a correction of the measured value for the mass flow and/or the flow velocity performed and/or a report concerning the state of at least one of the at least three sensor elements generated and output.

In the block diagram shown in FIG. 5, by way of example, in a first time interval 13a, S1 and S2 are heated, while S3 remains unheated. In a second (third) time interval 13b (13c), then S1 and S3 (S2 and S3) are heated, while, in turn, S2 (S1) remains unheated. Before each changing of the heated sensor elements, optionally anew a temperature reconciliation 12 can be performed, and, in given cases, a further temperature correction term ΔT_{kor,1,2} or ΔT_{kor,1,3} ascertained. These options are indicated by the arrows connecting different intervals 13a,13b and 13c and the section for the temperature reconciliation 12.

A opportunity to win information concerning the state of at least one of the at least three sensor elements results from calculating the respective power coefficient PC(S1,S2), PC(S1,S3), PC(S2,S3), PC(S3,S2), PC(S3,S1) and/or PC(S2,S1) and the respective decision coefficients in each of the time intervals 13a,13b,13c. From a comparison of the different decision coefficients, in turn, it can be ascertained, for which of the three sensor elements S1, S2, S3 the thermal resistance has changed. Sometimes this may not work. Depending on size of the change of the thermal resistance of a given sensor element, either, in case the change is only small, a correction of the ascertained measured value for the mass flow φ_{M} and/or the flow velocity v_{F} can be performed. If, however, the change is greater than a predeterminable limit value, then a report concerning the state of the respective sensor element S1,S2,S3 or that the thermal resistance of at least one of the at least three sensor elements S1, S2, S3 has changed, is generated and output. In the case, in which it is known, for which of the at least three sensor elements S1, S2, S3 a change of the thermal resistance has taken place, measurement operation corresponding to the normal operating mode 11 can be performed with the remaining two functional sensor elements, until the drifted sensor element is serviced.

Depending on configuration, all three time intervals 13a,13b,13c do not need to be performed, because, for example, either none of the sensor elements S1,S2,S3 show a change of thermal resistance, or already in the first or second time interval, it is clear, for which of the sensor elements S1,S2,S3 a change of the thermal resistance has occurred.

To the extent that all three time intervals 13a, 13b and 13c are passed through, then three different statements of diagnostic information 14,14′,14″ (D1, D2 and D3) are obtained, which result from a comparison of the power coefficients ascertainable in each of the time intervals 13a,13b13c, for example, based on the respective decision coefficients. Through a comparison of the three statements of diagnostic information 14 D1, D2 and D3, it can then, in given cases, be ascertained, for which of the three sensor elements S1, S2 or S3 the thermal resistance has changed.

In the example shown here, a direction detection 3a is, furthermore, performed in the second 13b and third 13c time intervals of the diagnostic mode 13. Since the flow diagram shown here is tailored for a sensor of FIG. 3, the locally surrounding flow 3b″ of S3 is different from the locally surrounding flows 3a of S1 and S2, so that a direction detection 3a can be completed most effectively, when one of the two heated sensor elements is S1 or S2 and the second heated sensor element is S3.

In the third time interval 13c, S2 and S3 are heated. Correspondingly, for a continuous determining of the mass flow φ_{M} and/or the flow velocity v_{F}, at least for this time interval, a change should occur from S1 to S2. Before the change, there is, consequently, an opportunity especially for a temperature reconciliation 12. Somewhat the same holds in the case, in which a change of the thermal resistance of S3 is detected. The customer should, however, in given cases, be informed by means of a report that maintenance of the thermal, flow measuring device 1 is necessary.

If there results from the diagnostic mode 13 that the thermal resistance of S1 has changed, then one can switch for the normal mode 11 from S1 to S2, so that a continuing correct and exact determining of the mass flow φ_{M} and/or the flow velocity v_{F} is assured.

Depending on need of the customer, the diagnostic mode 13 and/or the direction detection 3a are/is activated. It is, however, likewise possible to perform the diagnostic mode 13 and/or a direction detection 3a continuously and in parallel with determining the mass flow φ_{M} and/or the flow velocity v_{F}. The direction detection 3a is e.g. in FIG. 5 repeatedly performed in the time intervals 13b and 13c and the information won concerning the flow direction R₂ and R₃ can, for example, be compared with one another for checking the measurement results. A comparison of two sensor elements arranged at equivalent positions and equally embodied does not, normally, lead to an exact direction detection.

For evaluating the diagnostic information D1, D2 and D3 won in the different time intervals 13a, 13b and 13c of the diagnostic mode 13, it can be assumed that a fouling and/or accretion formation on at least one of the three sensor elements results in a negative shifting of the respective power coefficients compared with the normal state, while the occurrence of an abrasion leads to a positive shifting.

If an arrangement and/or embodiment of the thermal, flow measuring device other than that utilized for the diagram of FIG. 5 is selected, the individual steps must, in given cases, be slightly modified. Independently of the number of sensor elements as well as their arrangement and/or embodiment, the basic procedure of changing between a normal mode 12 and a diagnostic mode 13 remains. Likewise there remains the opportunity, optionally, to perform a temperature reconciliation 12 and/or a direction detection 3a. Moreover, each method of the invention utilizes a pairwise comparison of the temperatures and/or heating powers of two heated sensor elements and the temperature of a third non-heated sensor element and/or a variable derived from at least one of the temperatures and/or heating powers. In such case, different sensor elements can be heated in different time intervals.

### LIST OF REFERENCE CHARACTERS

1 thermal, flow measuring device
2 pipeline, or measuring tube
3 medium
3a macroscopic flow direction
3b local flow surrounding a sensor element
4 active sensor element
4a,4b,4c different arrangements/embodiments of an active sensor element
5 heatable temperature sensor
5a,5b,5c heatable temperature sensor of the sensor elements 4a,4b,4c
6,6a housing
7 passive sensor element
8 temperature sensor
9 electronics unit
10 bluff body
11 normal operating mode
12 temperature reconciliation
13 diagnostic mode
13a,13b,13c first, second, third time intervals of the diagnostic mode
14 diagnostic information
S1 first sensor element, e.g. 4a
S2 second sensor element, e.g. 4b
S3 third sensor element, e.g. 4c
Pxy heating power supplied sensor element Sx in the time interval y
Txy temperature of the sensor element Sx in the time interval y
PC power coefficient
DC decision coefficient
D₁,D₂,D₃ diagnostic information
R₂ R₃ flow direction of the medium#
φ_{M} mass flow
v_{F} flow velocity
T_{M} temperature of the medium
ΔT_{kor,x,y} temperature correction term for reconciliation between sensor elements x and y

1-15. (canceled)

16. A thermal flow measuring device for determining and/or monitoring the mass flow and/or the flow velocity of a flowable medium through a pipeline, comprising:
at least three sensor elements; and
an electronics unit, wherein:
each of said at least three sensor elements is at least partially and/or at times in thermal contact with the medium, and includes a heatable temperature sensor;
said electronics unit is embodied:
to heat each of said three sensor elements with a heating power:
to register their temperature;
to heat at least two of said at least three sensor elements simultaneously;
continuously to ascertain the mass flow and/or the flow velocity of the medium, and simultaneously;
to provide information concerning the state of at least one of said at least three sensor elements, and in a case that a malfunction and/or a deposit occurs on at least one of said at least three sensor elements, to perform a correction of the measured value for the mass flow and/or the flow velocity and/or to generate and to output a report concerning the state of said at least one sensor element.

17. The thermal, flow measuring device as claimed in claim 16, wherein:
said electronics unit is embodied to determine the flow direction of the flowable medium.

18. The thermal, flow measuring device as claimed in claim 16, wherein:
said electronics unit is embodied, without interruption, to ascertain the mass flow and/or the flow velocity, to determine the flow direction of the medium and/or to provide information concerning the state of at least one of the at least three sensor elements.

19. The thermal, flow measuring device as claimed in claim 16, wherein:
at least one of said at least three sensor elements has a first embodiment with reference to geometry, construction and material, and at least a second of said at least three sensor elements has a second embodiment different from the first.

20. The thermal, flow measuring device as claimed in claim 16, wherein:
at least two of said at least three sensor elements are arranged at first positions within the pipeline equivalent with reference to locally surrounding flow of the medium; and
at least one of said at least three sensor elements is arranged at a second position within the pipeline different from the first positions with reference to locally surrounding flow of the medium.

21. The thermal, flow measuring device as claimed in claim 16, wherein:
at least one of said at least three sensor elements is arranged with reference to the longitudinal axis of the pipeline in direct vicinity before or behind a bluff body, or other flow influencing module.

22. The thermal, flow measuring device as claimed in claim 21, wherein:
said bluff body has a cross sectional area in the form of at least one of a triangle, a rectangle, a parallelogram, a trapezoid, a circle or an ellipse.

23. The thermal, flow measuring device as claimed in claim 16, wherein:
exactly three sensor elements are included; and
at least one of said three sensor elements is arranged in direct vicinity of a bluff body, or other flow influencing module.

24. The thermal, flow measuring device as claimed in claim 23, wherein:
the first and the second sensor elements are arranged symmetrically on oppositely lying sides of an imaginary axis parallel to the pipeline;
the third sensor element is arranged on the imaginary axis; and
between the imaginary connecting line through the first and the second sensor element and the third sensor element a bluff body is arranged, whose separation from the third sensor element is less than that from said imaginary connecting line.

25. A method for operating, in a normal operating mode and in a diagnostic mode, a thermal flow measuring device for determining and/or monitoring mass flow and/or flow velocity of a flowable medium through a pipeline and having at least three sensor elements and an electronics unit, comprising the steps of:
in the normal operating mode heating at least one of the at least three sensor elements with a tunable heating power;
registering its temperature, and determining the mass flow and/or the flow velocity of the medium; and
in the diagnostic mode performing at least the following steps:
heating a first sensor element with a first heating power and registering its temperature;
heating a second sensor element with a second heating power and registering its temperature;
registering the temperature of the medium by means of a non-heated, third sensor element;
continuously determining from the heating power and/or temperature of the first or second sensor element and/or at least one variable derived from at least one of these variables, mass flow and/or flow velocity of the medium, and, simultaneously;
deriving information concerning the state of at least one of the at least three sensor elements and/or performing a connection of the measured value for the mass flow and/or the flow velocity and/or generating and outputting from a pairwise comparison of the temperatures and/or heating powers of the first and/or second sensor element and the temperature of the third sensor element and/or from at least one variable derived from the temperature and/or heating powers.

26. The method as claimed in claim 25, wherein:
the flow direction of the medium is ascertained from a pairwise comparison of the temperatures and/or heating powers and/or from at least one variable derived from the temperatures and/or heating powers.

27. The method as claimed in claim 25, wherein:
the mass flow and/or the flow velocity, the flow direction of the medium and/or information concerning the state of at least one of the at least three sensor elements are ascertained without interruption and at the same time.

28. The method as claimed in claim 25, wherein:
before the simultaneous heating of at least two of the at least three sensor elements with a tunable heating power, a reconciliation of the measured media temperatures is performed, and, in given cases, a temperature correction term calculated and applied to all following measurements.

29. The method as claimed in claim 25, wherein:
a comparison of the power coefficients PC of the at least three sensor elements is performed.

30. The method as claimed in claim 25, wherein:
the flow measuring device has exactly three sensor elements, comprising method steps as follows:
in the normal operating mode, the first sensor element is heated with a first heating power, its temperature registered, and the mass flow and/or the flow velocity determined;
in a first time interval of the diagnostic mode the first and the second sensor elements are heated, the mass flow and/or the flow velocity are/is determined based on the first sensor element; and
a comparison of the power coefficients performed, in a second time interval of the diagnostic mode;
the first and the third sensor elements are heated;
the mass flow and/or the flow velocity are/is determined based on the first sensor element;
a comparison of the power coefficients performed, and the direction of the flowing medium ascertained therefrom, and in a third time interval of the diagnostic mode;
the second and the third sensor elements are heated;
the mass flow and/or the flow velocity are/is determined based on the second sensor element; and
a comparison of the power coefficients performed, and the direction of the flowing medium ascertained therefrom, wherein based on the comparisons of the power coefficients in the three time intervals, information is derived concerning the state of at least one of the at least three sensor elements and a correction of the measured value for the mass flow and/or the flow velocity performed and/or a report concerning the state of the at least one sensor element generated and output.
